(19) United States
(12) Patent Application Publication
(10) Pub. No.: US 2016/0201862 A1
(43) Pub. Date: Jul. 14, 2016

(54) COMPACT MODULAR LIGHT FITTING UNIT

(71) Applicant: BEYOND LIGHTING PTY LTD, Tempe, NSW (AU)

(72) Inventor: Allan TURNBULL, Caringbah (AU)

(21) Appl. No.: 14/916,838

(22) PCT Filed: Sep. 5, 2014
(86) PCT No.: PCT/AU2014/000882

§ 371 Date: Mar. 4, 2016

(30) Foreign Application Priority Data
Sep. 5, 2013 (AU) 2013903396
Nov. 4, 2013 (AU) 2013904254

(51) Int. Cl. F21S 8/04; F21V 7/00; F21V 23/00; F21V 3/04

(52) U.S. Cl. CPC F21S 8/04; F21V 3/0445; F21V 7/005; F21V 23/003; F21Y 2103/00

(57) ABSTRACT

A ceiling mountable light box including: a first outer backing case having an elongated light source mounted thereon with associated light source driving electronics; a reflection subassembly, including an elongated diffuser and a series of reflection surfaces, the reflection subassembly adapted to mate with the first outer backing case, such that, the reflection surfaces surround the elongated light source when mated together. Preferably, the elongated light source can be interchangeable between fluorescent or LED and the light box can be adapted to fit in an overall project specific frame.

### FIELD OF THE INVENTION

The present invention relates to the field of light boxes for the reflection of electric light in buildings and, in particular, discloses a compact efficient modular light box that can be retrofitted to include an LED lighting system.

### BACKGROUND

Any discussion of the background art throughout the specification should in no way be considered as an admission that such art is widely known or forms part of common general knowledge in the field.

In office and industrial buildings, fluorescent lighting has been extremely common for many years. Normally the fluorescent lights are mounted in a light box for reflection of the emitted light into the building space.

Often, when a new building fit out is required, in say an office space, the lighting is stripped from the office space to provide a clean working space. This can be a highly inefficient utilisation of building resources

Further, in a constant drive to lower energy usage, LED lighting is conjectured to begin replacing fluorescent lighting, either in a retrofitting or replacement. Unfortunately, many decision makers in the installation of lighting fixtures in buildings are undecided on whether installation of fluorescent or LED is more appropriate. Further, as LED technology evolves, it may become more compelling to update previously installed lighting from fluorescent to LED.

### SUMMARY OF THE INVENTION

It is an object of the invention, in its preferred form to provide an improved form of lighting box.

In accordance with a first aspect of the present invention, there is provided a ceiling mountable light box including: a first outer backing case having an elongated light source mounted thereon with associated light source driving electronics; a reflection subassembly, including an elongated diffuser and a series of reflection surfaces, the reflection subassembly adapted to mate with the first outer backing case, such that, the reflection surfaces surround the elongated light source when mated together. The elongated light source can include either LED or Fluorescent lights.

Preferably, the light box also includes a detachable front frame mating with the first outer backing case and reflection subassembly for mounting in a ceiling. The detachable front frame can be constructed to suit any specific project. The reflection surfaces are preferably coated with a 3M reflected Light Enhancement film. The reflection sub assembly further preferably can include a diffuser plate surrounding an opposed side of the elongated light source. The reflection surfaces can include substantially concave surfaces. The outer backing case preferably can include emission source control electronics mounted thereon.

In accordance with a further aspect of the present invention, there is provided a ceiling mountable light box including: an outer backing case for mounting a reflection sub assembly; a reflection sub assembly, including an axial elongated emission source and a series of reflection surfaces surrounding one side of the elongated emission source.

The unit can also include one of a series of detachable front frames, for mounting in a ceiling.

### BRIEF DESCRIPTION OF THE DRAWINGS

Embodiments of the invention will now be described, by way of example only, with reference to the accompanying drawings in which:

FIG. 1 illustrates an isometric view of a light box of a first embodiment;

FIG. 2 illustrates a photograph of the three portions of a disassembled light box;

FIG. 3A to FIG. 3C illustrates a plan view of an assembled light box

FIG. 4 is an exploded side plan view of a light box;

FIG. 5 is an exploded end plan view of a light box;

FIG. 6 illustrates a front view of the reflector sub assembly and gear housing cover;

FIG. 7 is an isometric view of a portion of the reflector sub assembly;

FIG. 8 illustrates a sectional view through the arrangement of FIG. 7;

FIG. 9 is a photograph of an assembled light box.

FIG. 10 illustrates an isometric exploded view of a light box of a second embodiment;

FIG. 11 illustrates an exploded end plan view of the arrangement of FIG. 10, further illustrating the alternative forms of gear covers; and

FIG. 12 illustrates an end plan view of an assembled unit.

### DETAILED DESCRIPTION

A first embodiment provides a modular unit which can be standardised upon to provide both LED and Fluorescent illumination capabilities.

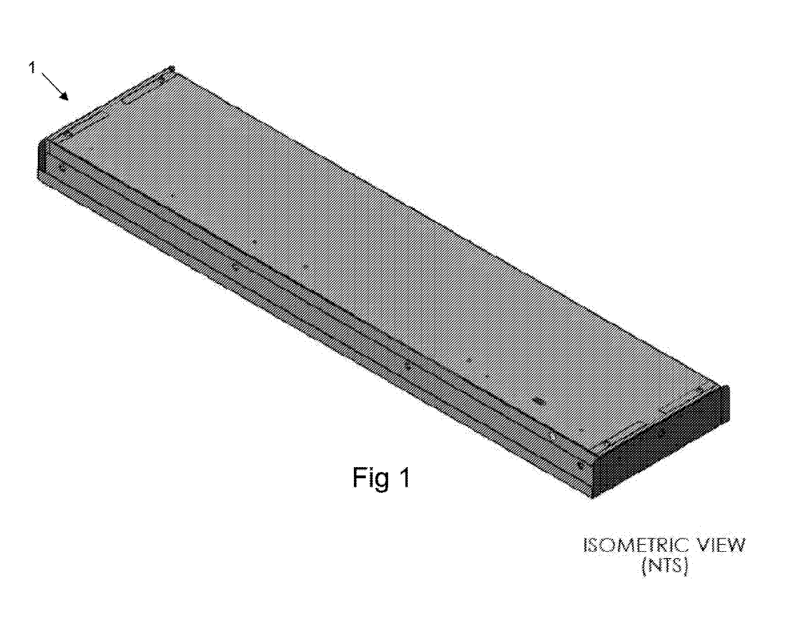

The first embodiment is initially shown in an assembled form 1 in FIG. 1 which consists of an outer light box 1 formed of a sheet metal material such as aluminium. FIG. 1 illustrates the back portion of the light box, when viewed from behind.

The light box of the first embodiment can be constructed of a standard size, for example a 1200×300 mm and can be made up of three parts which can be independently constructed.

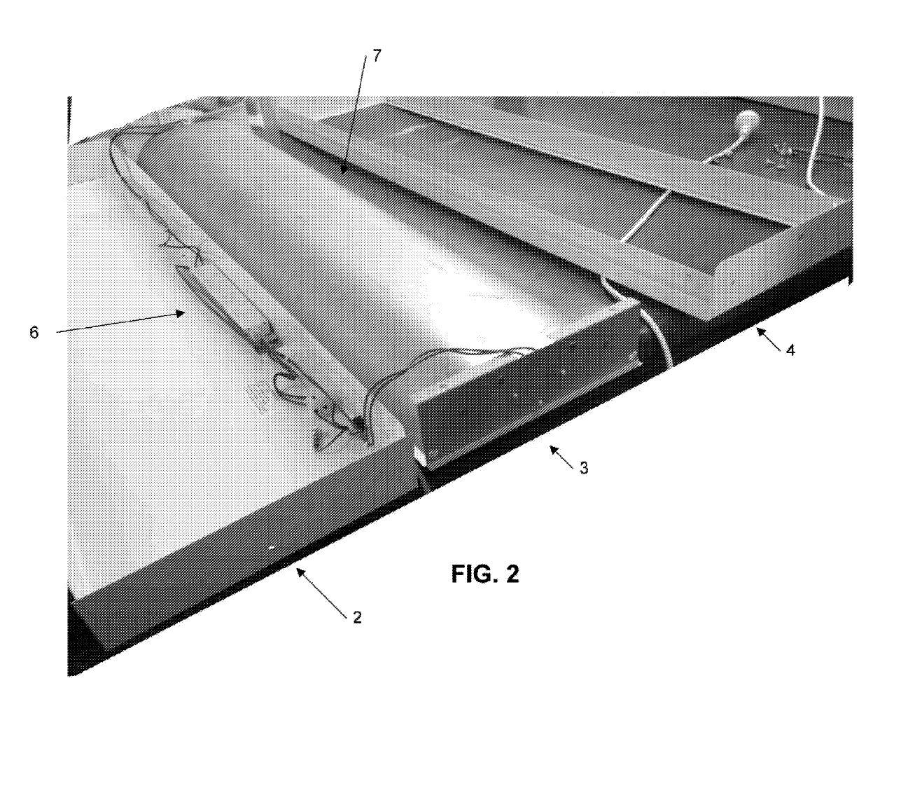

FIG. 2 illustrates a photograph of a portion of the three parts. They include an outer shell gear housing cover 2 which can house any necessary starter electronics or electronic drive system 6 for the Fluorescent or LED lights. An inner shell reflector sub assembly 3 is separately formed and includes a back reflection surface for reflecting light out from the light source. The inner shell 3 is bolted inside of the outer shell 2 which are then both fitted to a face frame 4 to form an overall light box unit.

Whilst separately assembled, each of the parts can be screwed together to provide the overall modular light box.

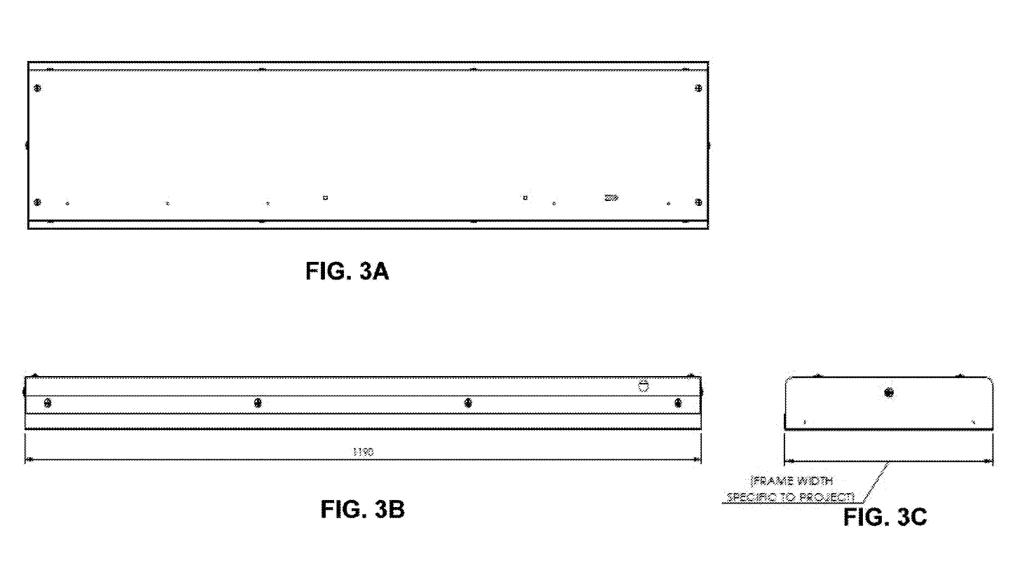

FIG. 3A to FIG. 3C illustrates a plan view of the outer box.

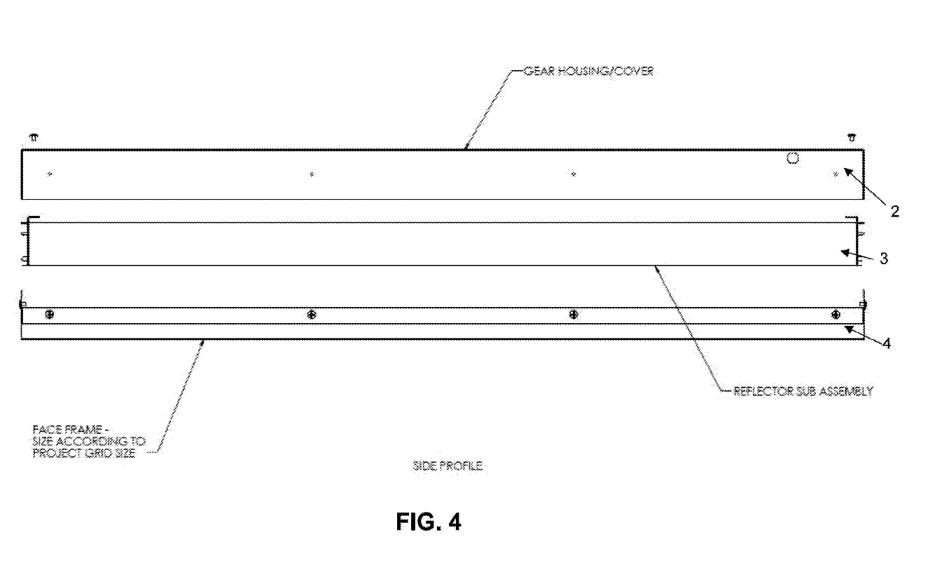

FIG. 4 illustrates the three parts of FIG. 2 in a side plan exploded view, illustrating how they mate together.

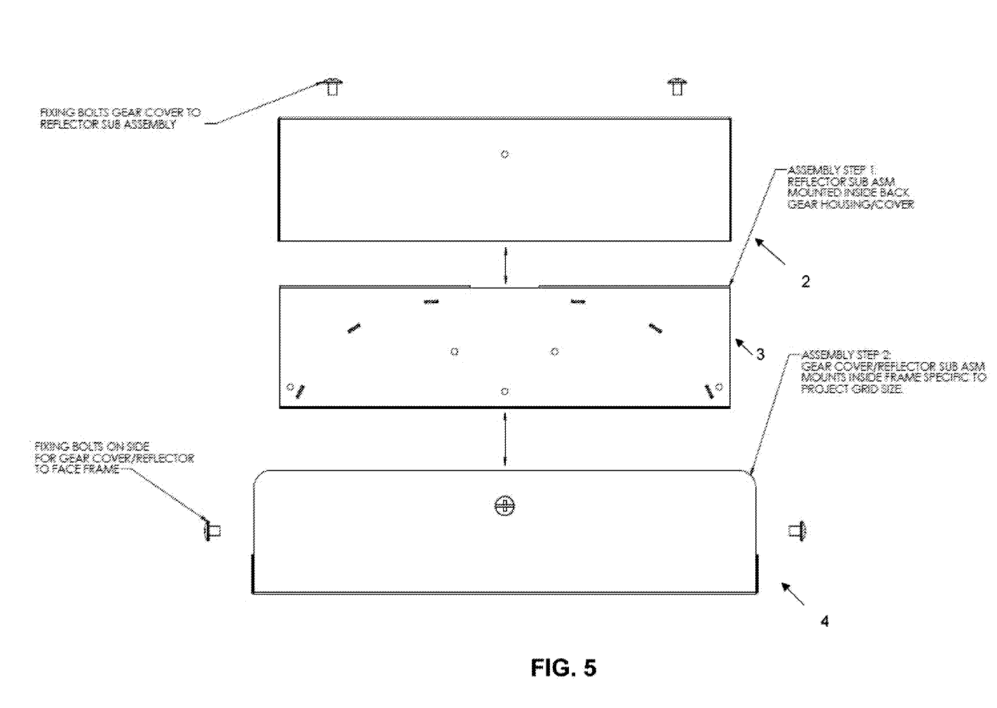

FIG. 5 is a corresponding end plan exploded view illustrating the mating assembly of the three units 2-4.

As noted above, the units 2, 3 can be made of a standard size, with the frame 4 being specific to the project requirements of the lighting installation.

In this manner, the units 2, 3 can be constructed in bulk for both fluorescent and LED light boxes and bolted to a project specific frame so as to provide modular advantages.

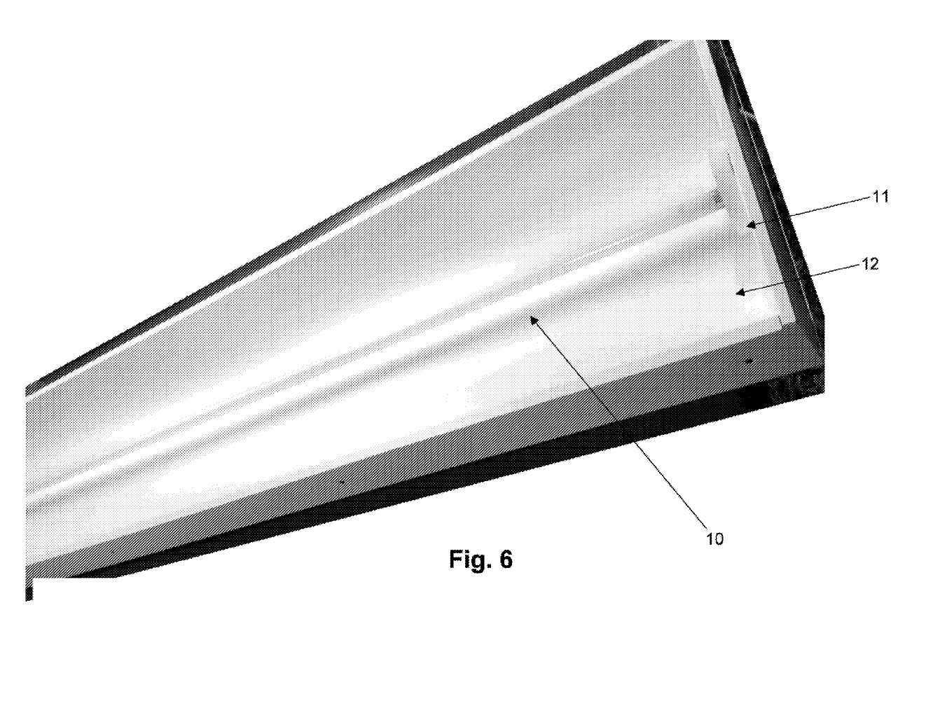

Turning now to FIG. 6, there is illustrated a photograph of a front view of an assembled form of the gear housing cover and reflective sub assembly. In this case, the reflective sub assembly includes a mounted fluorescent tube 10. In use a diffuser cover is placed around the fluorescent tube 10, being mounted in slot or ridge 11.

Importantly, along the reflective concave surface 12 of the sub assembly is placed a reflective light enhancing film tape such as the 3M Light Enhancement Film (LEF) 3635-100 manufactured by the 3M company. The light enhancing film acts to provide superior long lasting reflection capabilities, thereby reducing overall power requirements. Through the utilisation of this film, the need for powder coating of the surfaces of the reflective sub assembly is eliminated.

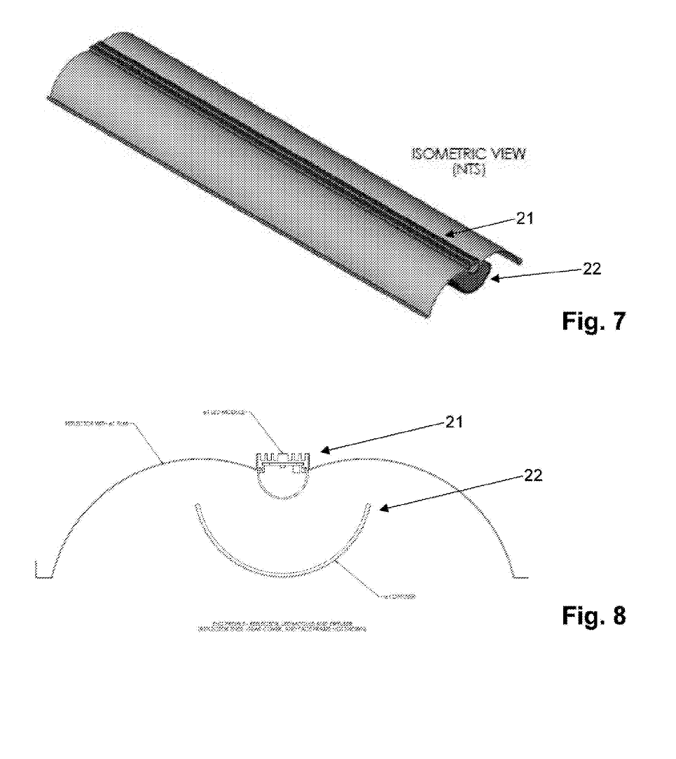

It will be evident that separate subassemblies can be constructed for LED or fluorescent lighting. FIG. 7 illustrates one form of subassembly showing the back surface of the reflector for an LED type light box sub assembly. The arrangement includes a mounted LED strip 21 and diffuser 22.

FIG. 8 illustrates a sectional view through the arrangement of FIG. 7, including LED strip 21 and diffuser 22.

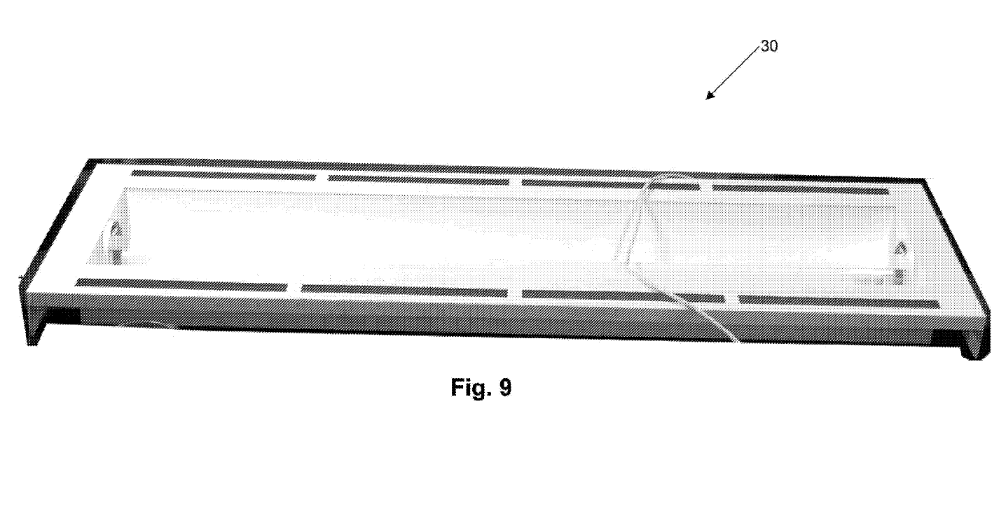

FIG. 9 illustrates a photograph of a final arrangement of the first embodiment ready for mounting in the ceiling. The front frame can be changed depending on architectural requirements (for example, various air conditioning vents etc may be required).

It will be evident that the arrangement of the first embodiment provides for an extremely modular design that can accommodate either LED or Fluorescent lighting in the same design in an interchangeable manner Further, the three parts can be separately manufactured in bulk and screwed together for placement in a building. Further, different face plate frames can be utilised so that only a standard size sub assembly is required which is, in turn, attached to the desired face plate frame before insertion in the roof cavity. The use of the 3M reflector film also acts to enhance the light projection and distribution from the emission source.

### Second Embodiment

The second embodiment provides a modular unit for light fitting which is adapted to receive both LED and Fluorescent illumination units for lighting, and can be simply swapped from one to the other.

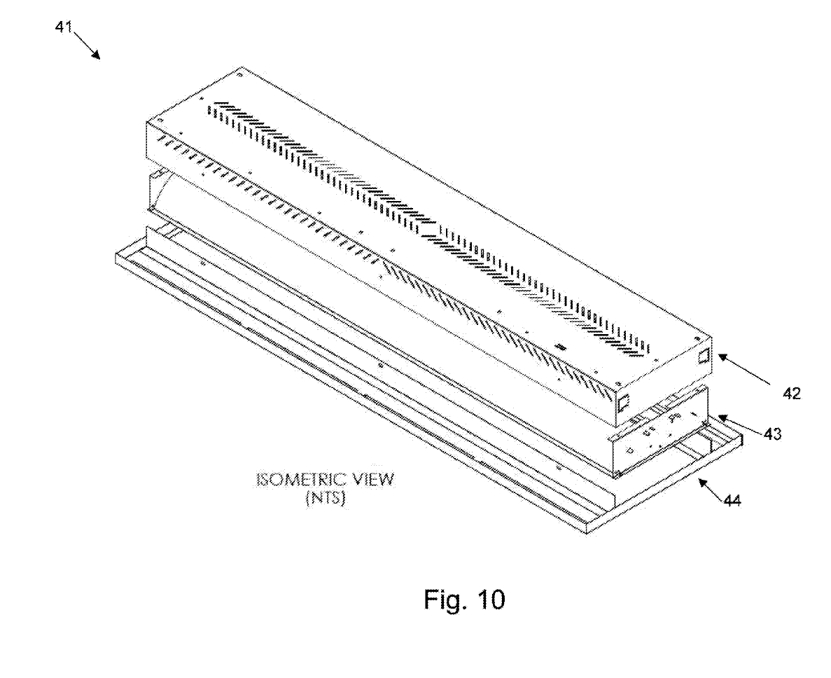

The second embodiment is initially shown in a side isometric exploded form 41 in FIG. 10. The second embodiment is made up of three components 42-44. In includes an outer shell gear cover 42 which comes in two interchangeable forms. A first form is for housing Fluorescent lights and driving electronics and a second form is for housing LED lights and LED driving electronics. An inner shell reflector sub assembly 43 is separately formed and includes a back reflection surface for reflecting light out from the light source. The inner shell 43 is bolted inside of the outer shell gear cover 42 which are then both fitted to a face frame 44 to form an overall light box unit.

Whilst separately assembled, each of the parts can be screwed together to provide the overall modular light box. Further, the gear cover 42 can be formed in two types of units, one being used for Fluorescent lights and one being used for LED lights.

The light box can be constructed of a standard size, for example a 1200 ×300 mm and can be made up of three parts which can be independently constructed.

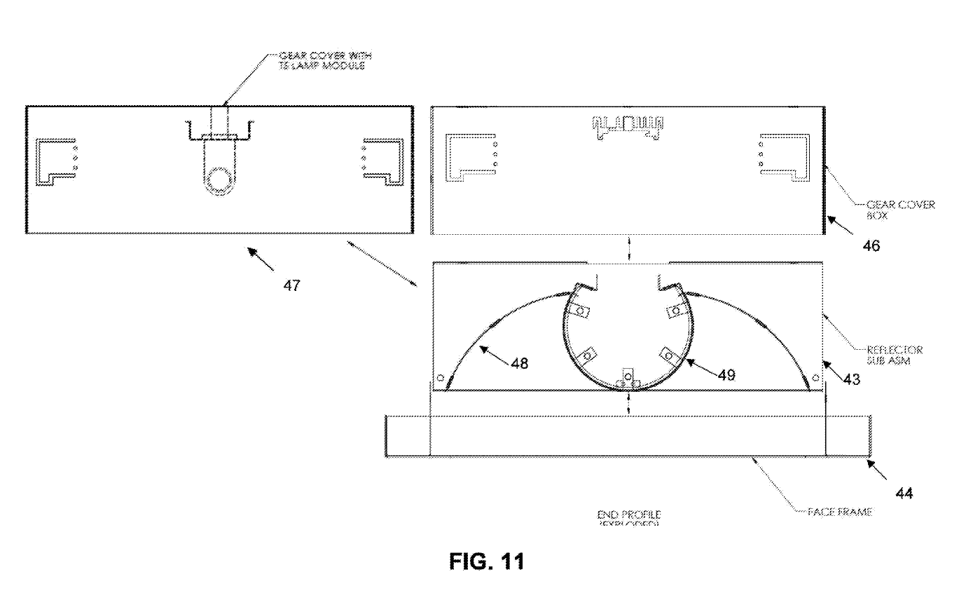

FIG. 11 illustrates an exploded plan view of the end portion of the arrangement of FIG. 10. In this arrangement, the gear cover can be interchangeably formed with a first cover shown adapted to provide LED lighting 46 and a second cover 47 adapted to provide for Fluorescent lights. Next, the inner shell 43 provides all the reflector subassembly for reflection of the light emitted from the fluorescent tube or LED lighting. The two units can be interconnected together and in turn fitted to an interchangeable frame and front plate 44.

The inner shell 43 includes a diffuser cover 49 for reflection of light from the tube or LED. In use the diffuser cover is placed around the fluorescent tube or LED, being mounted in slot or ridge at each end. Importantly, again along the reflective concave surface 48 of the sub assembly is placed a reflective light enhancing film tape such as the 3M Light Enhancement Film (LEF) 3635-100 manufactured by the 3M company. The light enhancing film acts to provide superior long lasting reflection capabilities, thereby reducing overall power requirements. Through the utilisation of this film, the need for powder coating of the surfaces of the reflective sub assembly is eliminated.

Ideally the gear covers include all the associated ballast and wiring where required. In this manner, in order to replace one form of lighting with another, it is only necessary to replace the gear covers, with all wiring mounted on the gear cover box. The reflector subassembly 43 accepts both of the gear covers, 46, 47. The combined unit can then be mounted into a project specific frame 44.

As noted above, the units 47, 46 can be made of a standard size, with the frame 44 being specific to the project requirements of the lighting installation.

In this manner, the units 47, 46 can be constructed in bulk for both fluorescent and LED light boxes and bolted to a project specific frame so as to provide modular advantages.

It will be evident that the arrangement of the second embodiment provides for an extremely modular design that can accommodate either LED or Fluorescent lighting in the same design in an interchangeable manner Further, the three parts can be separately manufactured in bulk and screwed together for placement in a building. Further, different face plate frames can be utilised so that only a standard size sub assembly is required which is, in turn, attached to the desired face plate frame before insertion in the roof cavity. The use of the 3M reflector film also acts to enhance the light projection and distribution from the emission source.

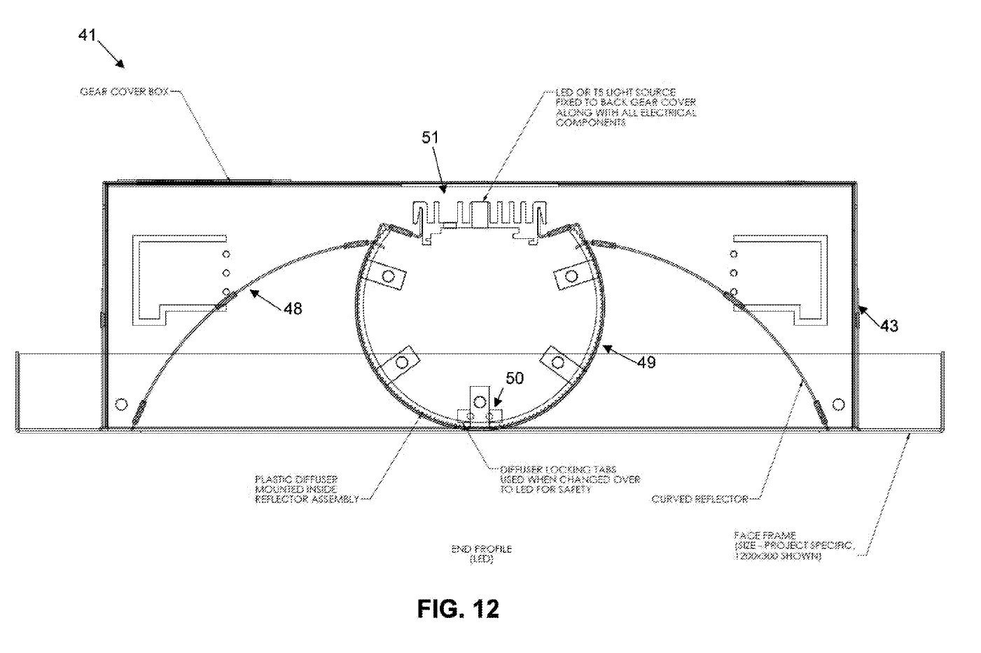

FIG. 12 illustrates an end plan view of the second embodiment in an assembled form.

The arrangement of FIG. 12 has a number of advantages. The diffuser plate 49 acts to project the light onto the reflector 48 in an even manner. Further, the almost circular cross section of the diffuser 49 acts to enhance the projection of light back to the apex area of the reflector 48. This provides for more even dispersion and enhanced projection of light.

Tabs 50 can be provided at each end of the frame for locking the diffuser in place preventing access. Various other end locking arrangements can be provided to permanently or temporarily lock the diffuser in place. These overcome a safety issue, especially when providing an LED arrangement in that it prevents access to the LED or associated electronics components 51 on the back of the frame. Further, the shape of the diffuser prevents side access to any internal electronics along the length of the diffuser.

As noted, the embodiments provide of the change of the face plate only, are cost effective to manufacture in 3 part form, and can be readily used in any building arrangement.

Interpretation

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A ceiling mountable light box including:
a first outer backing case having an elongated light source mounted thereon with associated light source driving electronics;
a reflection subassembly, including an elongated diffuser and a series of reflection surfaces, said reflection subassembly adapted to mate with the first outer backing case, such that, said reflection surfaces surround the elongated light source when mated together.

2. A light box as claimed in claim 1 further including a detachable front frame mating with the first outer backing case and reflection subassembly for mounting in a ceiling.

3. A light box as claimed in claim 2 wherein said elongated light source include either LED or Fluorescent lights.

4. A light box as claimed in claim 1 wherein said reflection surfaces are coated with a 3M reflected Light Enhancement film.

5. A light box as claimed in claim 1 wherein said reflection sub assembly further includes a diffuser plate surrounding an opposed side of the elongated light source.

6. A light box as claimed in claim 1 wherein said reflection surfaces include substantially concave surfaces.

7. A light box as claimed in claim 1 wherein said outer backing case includes emission source control electronics mounted thereon.

8. A light box as claimed in claim 1 further including a detachable project specific front frame, for mounting in a ceiling.

9. A light box as claimed in claim 1 wherein said elongated diffuser is substantially circular in cross section with the elongated light source mounted spaced apart from the center of the circular cross section.

10. A light box as claimed in claim 1 wherein the ends of the elongated diffuser and the reflection subassembly are mated together by a series of bendable tabs to either temporarily or permanently lock the elongated diffuser in place relative to the reflection subassembly.

11. A ceiling mountable light box including:
an outer backing case for mounting a reflection sub assembly; and
a reflection sub assembly, including an axial elongated emission source and a series of reflection surfaces surrounding one side of the elongated emission source.

12. A ceiling mountable light box as claimed in claim 2 wherein the outer baking case and reflection subassembly are assembled as an integral unit and the detachable front frame is attached separately to the integral unit.

13. A ceiling mountable light box as claimed in claim 2 wherein said detachable front frame includes edges which, when assembled, overlap the sides of the outer backing case and reflection subassembly.
